(19) United States
(12) Patent Application Publication
(10) Pub. No.: US 2015/0193643 A1
(43) Pub. Date: Jul. 9, 2015

(54) INFORMATION READER

(71) Applicant: Panasonic Intellectual Property Management Co., Ltd., Osaka (JP)

(72) Inventors: Hideyuki HASHI, Osaka (JP); Naoto YUMIKI, Osaka (JP)

(21) Appl. No.: 14/604,791

(22) Filed: Jan. 26, 2015

Related U.S. Application Data
(63) Continuation of application No. PCT/JP2013/004229, filed on Jul. 9, 2013.

(30) Foreign Application Priority Data
Jul. 27, 2012 (JP) 2012-166783

(51) Int. Cl. G06K 7/10

(52) U.S. Cl. CPC G06K 7/10732; G06K 7/10881

(57) ABSTRACT

An information reader according to the present technology includes a light source unit that applies light to an information pattern having a plurality of marks which are optically readable, an image reading unit that reads information from the information pattern, and a case that houses the light source unit and the image reading unit, and includes, at a tip, an opening through which the light from the light source unit is applied to the information pattern and into which light for reading information by the image reading unit enters. The light source unit includes an LED which is mounted on a flexible wiring plate, and a heat conducting unit provided on a rear surface opposite to a surface of the flexible wiring plate on which the LED is mounted.

### BACKGROUND

1. Field

The present technology relates to an information reader used for an information display apparatus capable of receiving handwriting input via a display surface of a display device.

2. Description of the Related Art

There has been known a technique of identifying a position of image information formed on a printing medium such as paper based on two-dimensional codes including encoded coordinate information provided on the printing medium (see Unexamined Japanese Patent Publication No. 2007-226577).

In addition, such a technology of handwriting input to a display device is known, for example, which detects coordinates on a display device via an input pen or the like by using a resistive touch system or a capacitive sensing system, for example, to display characters or other information based on the detected coordinate information. In a device of this type, a coordinate designation range on the display device is associated with a display screen of a display unit. When the input pen is moved on the display surface of the display device, information such as characters is displayed on the display screen in accordance with the movement of the input device.

### SUMMARY

An information reader according to the present technology includes: a light source unit that applies light to an information pattern having a plurality of marks which are optically readable; an image reading unit that reads information from the information pattern; and a case that houses the light source unit and the image reading unit, and includes, at a tip, an opening through which the light from the light source unit is applied to the information pattern and into which light for reading information by the image reading unit enters. The light source unit includes a light source that emits light, a flexible wiring plate on which the light source is mounted, and a heat conducting unit provided on a rear surface opposite to a surface of the flexible wiring plate on which the light source is mounted.

### BRIEF DESCRIPTION OF DRAWINGS

FIG. 1 is a view illustrating a schematic configuration of an information display apparatus according to an exemplary embodiment of the present technology;

FIG. 2 is a view schematically illustrating configurations of an electronic pen and a display device in the information display apparatus according to the exemplary embodiment of the present technology;

FIG. 3 is an explanatory view illustrating an example of an information pattern provided on a display surface of the display device;

FIG. 4A is an explanatory view illustrating an example of a method for obtaining position coordinates from the information pattern;

FIG. 4B is an explanatory view illustrating an example of the method for obtaining position coordinates from the information pattern;

FIG. 4C is an explanatory view illustrating an example of the method for obtaining position coordinates from the information pattern;

FIG. 4D is an explanatory view illustrating an example of the method for obtaining position coordinates from the information pattern;

FIG. 5 is a view schematically illustrating a configuration of a display panel with the information pattern, in the display device;

FIG. 6 is a perspective view illustrating an external appearance of the electronic pen according to the exemplary embodiment of the present technology;

FIG. 7 is a plan view illustrating the external appearance of the electronic pen according to the exemplary embodiment of the present technology as viewed in the horizontal direction;

FIG. 8 is a plan view illustrating the electronic pen according to the exemplary embodiment of the present technology as viewed from an opening formed at a tip of the electronic pen;

FIG. 9 is a perspective view illustrating an internal structure of the electronic pen according to the exemplary embodiment of the present technology in a state where a lower case is removed from the electronic pen;

FIG. 10 is a perspective view illustrating an enlarged part A shown in FIG. 9;

FIG. 11A is an explanatory view illustrating a state in which a user uses the electronic pen according to one exemplary embodiment of the present technology; and

FIG. 11B is an explanatory view illustrating another state in which a user uses the electronic pen according to one exemplary embodiment of the present technology.

### DETAILED DESCRIPTION

A liquid crystal display apparatus is hereinafter described as an example of an information display apparatus used with an information reader according to an exemplary embodiment of the present technology. However, the information display apparatus may be other types of devices such as an EL (electroluminescent) display device.

In the following description, excessively detailed explanation may be omitted. For example, description concerning details of matters already well known, or repeated description for substantially identical configurations may be omitted. These omissions are made for avoiding redundancy in the following description, and helping those skilled in the art easily understand the description.

The accompanying drawings and the following description are provided by the present inventors only for the purpose of helping those skilled in the art sufficiently understand the present technology, and therefore are not intended to limit the subject matters of the appended claims in any way.

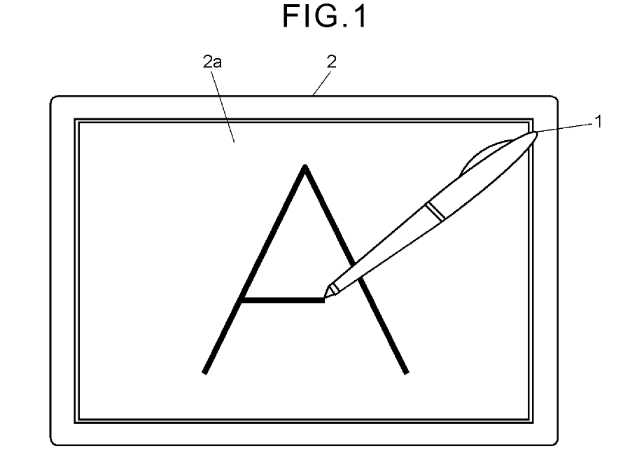

FIG. 1 is a view illustrating a schematic configuration of the information display apparatus including the information reader according to the exemplary embodiment of the present technology. As illustrated in FIG. 1, the information display apparatus includes optical electronic pen 1 functioning as an information reader for handwriting input, and display device 2 which has a display panel for receiving position information designated by electronic pen 1 to display characters, figures and the like on display surface 2a. While not illustrated in FIG. 1, an information pattern is provided in a display region of the display panel of display device 2, as a pattern which has a plurality of dot-shaped marks optically readable by electronic pen 1.

In the information display apparatus of the present technology, the information pattern showing position coordinates on display surface 2a is provided on display device 2. The information pattern is read by electronic pen 1 as an optical image pattern, to identify position information given from a user to display surface 2a by handwriting input. Specifically, electronic pen 1 executes operation for applying detection light to the information pattern provided on display device 2, and reading marks of the information pattern as an optical image pattern. By this method, tracks of electronic pen 1, i.e., handwriting of characters or the like input from the user by handwriting can be detected based on the position information read by electronic pen 1.

In addition, the information display apparatus transmits the position information read by electronic pen 1 to display device 2. Display device 2 executes operation for changing display information displayed on display surface 2a in accordance with the position information transmitted from electronic pen 1. Accordingly, the user is allowed to write characters, figures or the like into display surface 2a of display device 2 using electronic pen 1 in a manner of handwriting input of characters or the like to paper using a pen. Electronic pen 1 may be function as an eraser. In this case, the information pattern is read by electronic pen 1 in a manner similar to writing of characters, figures or the like to identify the position of electronic pen 1. Then, deletion operation is executed for practicing deletion of display information displayed on display surface 2a based on the identified position information.

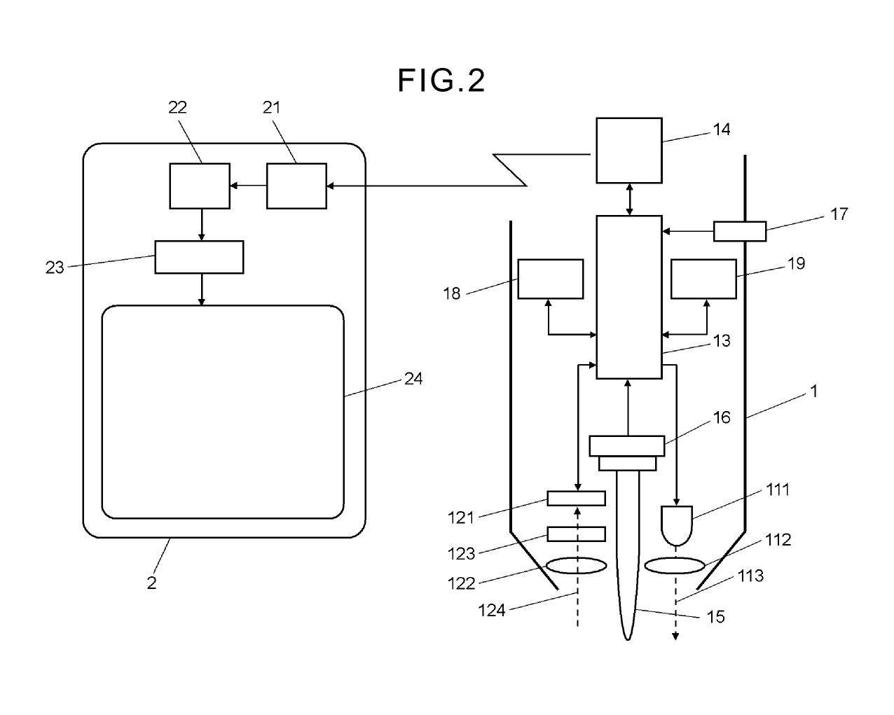

FIG. 2 is a view schematically illustrating configurations of electronic pen 1 and display device 2 in the information display apparatus according to the exemplary embodiment of the present technology.

As illustrated in FIG. 2, electronic pen 1 includes a light source unit functioning as an infrared light applying unit for applying infrared light to display device 2, and an image reading unit for receiving the infrared light reflected on display device 2 and reading the marks in the information pattern as an image of an optical image pattern. The light source unit is constituted by a light emitting diode (hereinafter abbreviated as LED) 111 as a light source for emitting at least infrared light, and includes condensing lens 112 for condensing the infrared light emitted from LED 111. The image reading unit is constituted by image reading unit 121 including an image sensor (CCD: Charge Coupled Device) for reading at least an image reflected on display device 2. The image reading unit further includes condensing lens 122 for condensing the infrared light which is reflected on display device 2 and which enters electronic pen 1, and infrared filter (IR filter) 123 for cutting off light with a wavelength within the visible light region to transmit infrared light.

Infrared light 113 emitted from LED 111 of electronic pen 1 is condensed by condensing lens 112, and applied to a particular position on display surface 2a of display device 2. On the other hand, infrared light 124 reflected on display device 2 is condensed by condensing lens 122, transmitted through infrared filter (IR filter) 123, and enters image reading unit 121.

Specifically, light in a reading region of a predetermined range on display surface 2a of display device 2 is condensed onto a light receiving surface of image reading unit 121 by condensing lens 122, and image reading unit 121 of electronic pen 1 reads an image of marks indicating position information of the information pattern included in the reading region. The image information read by image reading unit 121 is transmitted to processing circuit unit 13. Processing circuit unit 13 recognizes an image of dot-shaped marks included in the information pattern, and processes image data on the image pattern of the recognized marks to detect coordinates of a position designated by electronic pen 1. In addition, processing circuit unit 13 converts the read image information to data signals, and transmits the data signals to transmitting unit 14. Transmitting unit 14 transmits coordinate data to receiving unit 21 of display device 2 by a wireless communication.

Display device 2 controls panel driving circuit unit 23 by processing the data received by receiving unit 21 with process circuit unit 22. Panel driving circuit unit 23 controls display operation of display panel 24 to display characters, figures or the like on display surface 2a of display panel 24 based on the coordinate position recognized by electronic pen 1.

The foregoing series of operations are executed while pen tip 15 formed at a tip of electronic pen 1 is in contact with display surface 2a. Specifically, electronic pen 1 includes pen tip 15 at its tip, and pressure sensor 16 which senses pen pressure of pen tip 15 provided therein. When pen tip 15 of electronic pen 1 contacts display surface 2a of display device 2, this information is transmitted from pressure sensor 16 to processing circuit unit 13. In response to transmission of this signal, processing circuit unit 13 executes operation for processing reading output from image reading unit 121.

Electronic pen 1 may change the width or color depth of lines in accordance with output from pressure sensor 16. Specifically, the width or color depth of lines may be increased as the output from pressure sensor 16 is raised.

The reading operation is not limited to the operation executed when the tip of electronic pen 1 is in contact with display surface 2a, but may be operation executed when electronic pen 1 is separated from display surface 2a. In this case, reading operation may be executed in response to pressing of switch 17 provided for receiving input of a reading command from the user, for example.

Since the coordinate position of the pen tip of electronic pen 1 is different depending on inclination of electronic pen 1, angle sensor 18 is equipped within electronic pen 1 to detect the angle of electronic pen 1. For example, when electronic pen 1 is vertically positioned, the coordinates of the pen tip of electronic pen 1 are located immediately below electronic pen 1. On the other hand, when electronic pen 1 is greatly inclined, the coordinates of the pen tip are located far apart from the position immediately below electronic pen 1. Therefore, angle sensor 18 measures the inclination of electronic pen 1 to obtain inclination data of electronic pen 1, and transmits the inclination data to processing circuit unit 13. Based on the received inclination data, processing circuit unit 13 corrects information on the information pattern obtained by image reading unit 121. This configuration reduces the influence of inclination of electronic pen 1, thereby increasing accuracy of the obtained position information.

In addition, electronic pen 1 includes therein acceleration sensor 19 for detecting a moving speed (including acceleration) of electronic pen 1. Acceleration sensor 19 detects data on the moving direction and acceleration of electronic pen 1, and transmits the data to processing circuit unit 13. Processing circuit unit 13 executes calculation based on the moving direction data and acceleration data of electronic pen 1 transmitted from acceleration sensor 19 to obtain a moving amount and a moving direction of electronic pen 1.

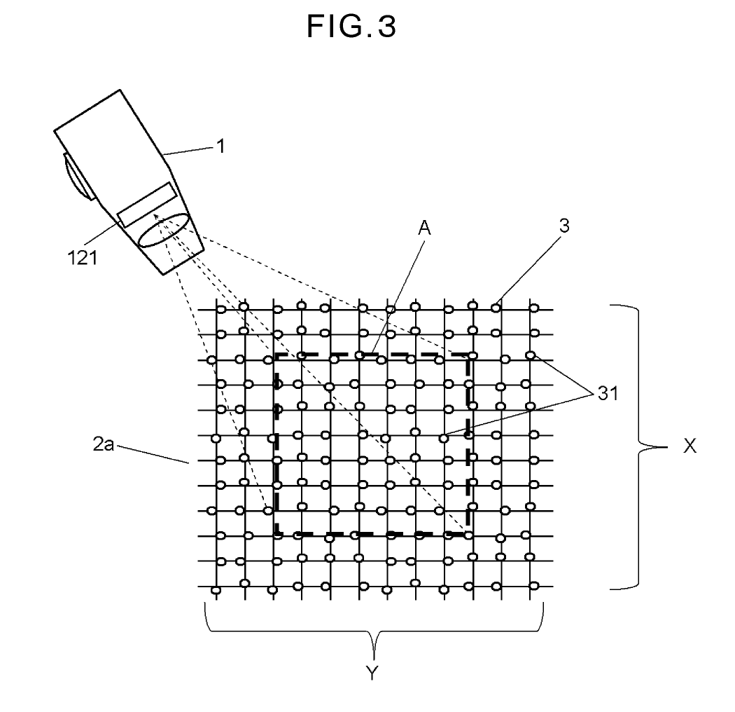

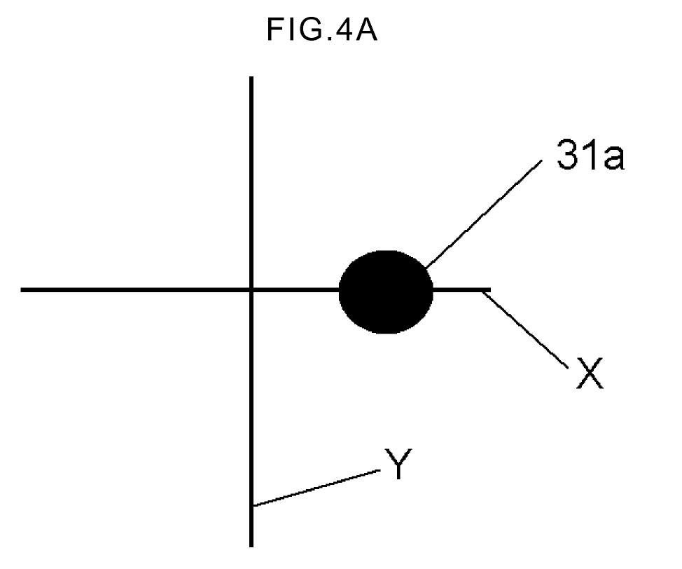

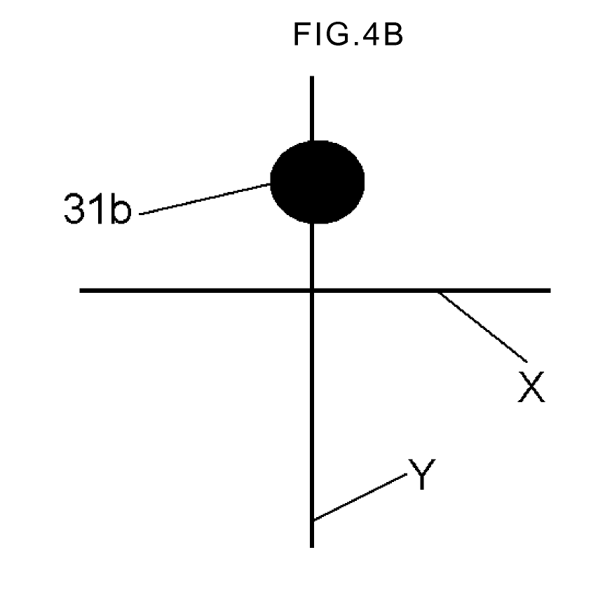

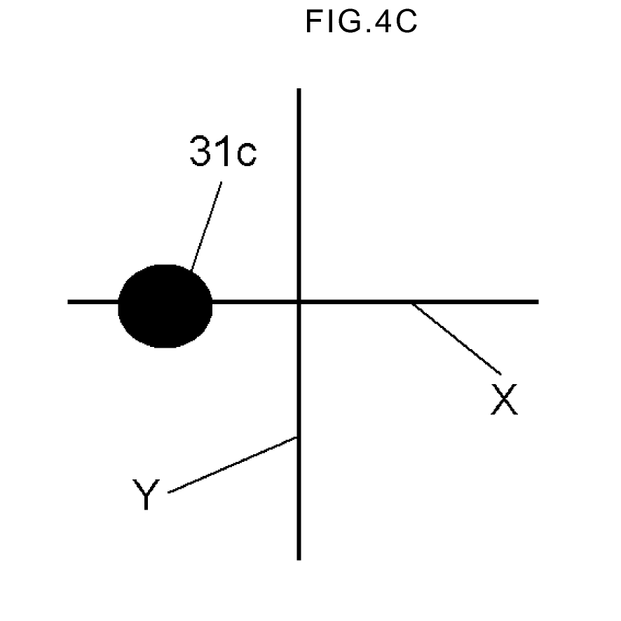

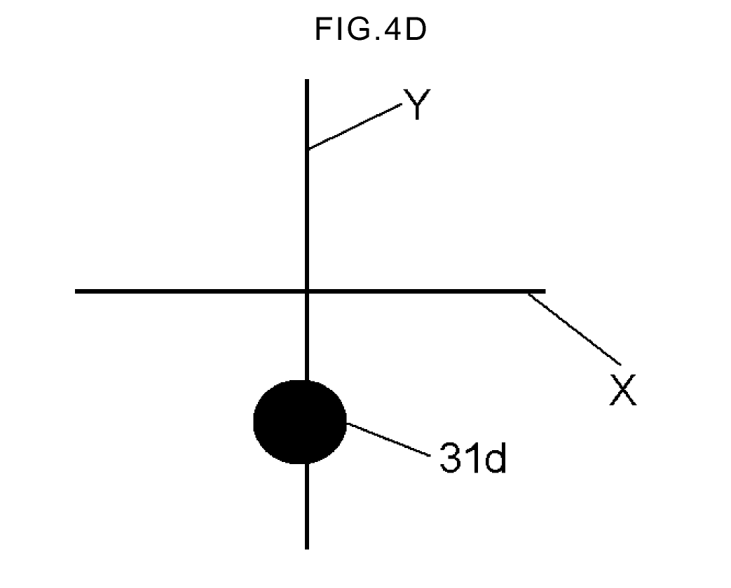

FIGS. 3 and 4A through 4D are explanatory views illustrating an example of the information pattern provided on display surface 2a of display device 2, and an example of a method for obtaining position coordinates from the information pattern.

As illustrated in FIG. 3, information pattern 3 having a plurality of marks 31 formed therein with a specific arrangement pattern is formed in the display region of display surface 2a of display device 2. Assuming that unit region A is defined as an m dots x n dots in display surface 2a, such as a 6 dots×6 dots pixel region, electronic pen 1 reads marks formed in information pattern 3 in the range of unit region A to recognize position coordinates designated by electronic pen 1.

FIGS. 4A through 4D are explanatory views illustrating an example of an arrangement pattern of marks 31 in information pattern 3, and a position coordinates converting method. In this example, marks 31 of information pattern 3 are provided on the basis of an intersection formed by reference line X and reference line Y in a grid form such that marks 31a, 31b, 31c, and 31d are located on the right side, upper side, left side, and lower side with respect to the intersection of reference lines X and Y in the arrangement pattern, as illustrated in FIGS. 4A through 4D.

For example, reference numbers “1”, “2”, “3”, and “4” indicating position coordinates are allotted to marks 31a, 31b, 31c, and 31d, respectively. Then, electronic pen 1 reads marks 31 formed in information pattern 3 within unit region A as illustrated in FIG. 3, to determine position coordinates in unit region A corresponding to the read marks 31.

Specifically, information pattern 3 includes thirty-six marks 31 each located at any one of four types of arrangement positions within 6 dots×6 dots unit region A, for example, and combines these arrangement patterns to form an information pattern indicating a coordinates position of a particular position in display unit 2a in correspondence with the particular position.

Mark 31 of information pattern 3 may be made of a material capable of transmitting visible light, and absorbing or reflecting infrared light to reduce the influence on a display image in the visible light region displayed on display surface 2a of display device 2. Alternatively, mark 31 may be made of a material having properties of light scattering or diffraction grating so as to vary the direction of incident light when infrared light is applied. In this case, light entering mark 31 having the properties of light scattering or diffraction grating is reflected (scattered, diffused, diffracted, phase-changed, or bended) on mark 31, and again output to the outside of display device 2, so that mark 31 can be detected based on the reflected light.

A configuration example of the display panel of display device 2 in the information display apparatus will be described.

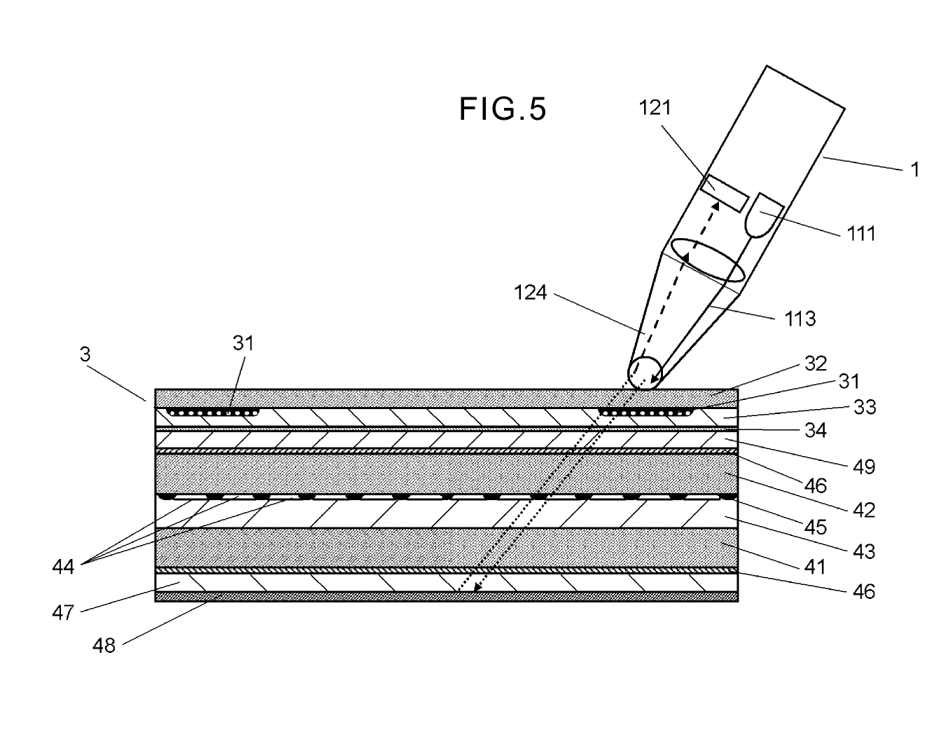

FIG. 5 is a view illustrating a schematic configuration of a display panel of display device 2 having an information pattern in the display panel. The display panel illustrated in FIG. 5 is an example of an active matrix type TFT color liquid crystal display panel.

As illustrated in FIG. 5, a liquid crystal display panel unit includes light-transmitting substrates 41 and 42 such as two sheets of glass substrate facing to each other, and liquid crystal material 43 sealed between substrates 41 and 42. Though not illustrated in the drawings, provided on lower substrate 41 of the liquid crystal display panel unit are thin film transistors serving as driving elements of liquid crystals, one of transparent electrodes, signal electrodes, and scanning electrodes. Provided on the surface of upper substrate 42 opposite to substrate 41 are color filters 44, black matrix 45, and the other transparent electrode. Each of color filters 44 is constituted by at least colors of red (R), green (G), and blue (B). Black matrix 45 functions as a light shielding member having openings through which the colors are transmitted, and is made of a metal thin film such as chrome shielding light on boundaries of the respective colors. Liquid crystal material 43 is disposed between the transparent electrodes formed on two substrates 41 and 42. Moreover, polarizing plate 46 is affixed to each of the outer surfaces of substrates 41 and 42.

Color filter 44 is not limited to of the RGB type, but may be filter having pixels in colors of cyan (C), magenta (M), and yellow (Y). Pixels in color of white (W) may also be included.

Surface light source member 47 and diffusing reflection sheet 48 constituting a backlight device are provided on the rear surface side of the liquid crystal display panel unit, i.e., polarizing plate 46 side of lower substrate 41. On-Cell type capacitance touch panel 49 is provided on the display surface side of the liquid crystal display panel unit, i.e., polarizing plate 46 side of upper substrate 42. Touch panel 49 may be constituted by an In-Cell type or a pressure sensitive resistance type, for example, or may be eliminated.

The liquid crystal display panel unit has a plurality pixels disposed in matrix, each constituted by sub-pixels having a plurality emission colors. The liquid crystal display panel unit controls ON and OFF of thin film transistors of the sub pixels constituting each of the pixels to selectively control the polarization of liquid crystal material 43, thereby achieving color display of characters and images based on the control.

Provided on touch panel 49 of the liquid crystal display panel unit is information pattern 3 having a plurality of marks 31 read by electronic pen 1 to obtain position information. As illustrated in FIG. 5, information pattern 3 has a plurality of circular or square marks 31 formed in a predetermined arrangement pattern and disposed on resin light-transmitting base film 32, and light-transmitting resin layer 33 formed on base film 32 in such a manner as to surround marks 31 as a layer for adjusting refractive indexes. Adhesive layer 34 made of a light-transmitting adhesive material is further provided on resin layer 33 to affix base film 32 to the upper side of touch panel 49 of the liquid crystal display panel unit via adhesive layer 34 in such a position that base film 32 of information pattern 3 is located on the display surface side.

Marks 31 of information pattern 3 is made of a material capable of transmitting visible light and absorbing infrared light to reduce the influence on a color display image in the visible light region displayed on the liquid display panel unit.

As illustrated in FIG. 5, infrared light 113 emitted from electronic pen 1 is initially applied to information pattern 3. In this case, infrared light 113 is absorbed at the positions of marks 31 in information pattern 3. However, infrared light 113 passes through the liquid crystal display panel unit at positions outside of marks 31, is reflected on diffusing reflection sheet 48, and enters electronic pen 1. Entering infrared light 124 is read by electronic pen 1 using image reading unit 121, whereby detection of coordinate information is achieved based on marks 31 formed in information pattern 3.

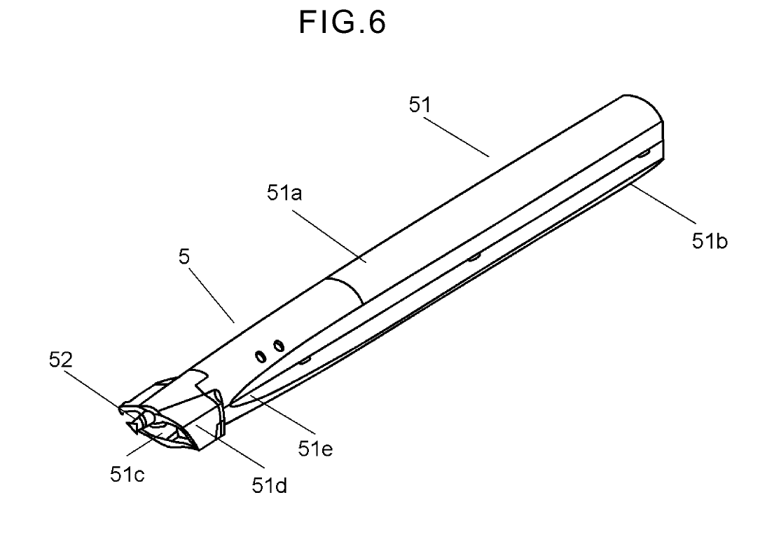

An electronic pen as the information reader according to the exemplary embodiment of the present technology will be hereinafter described with reference to FIGS. 6 through 11B.

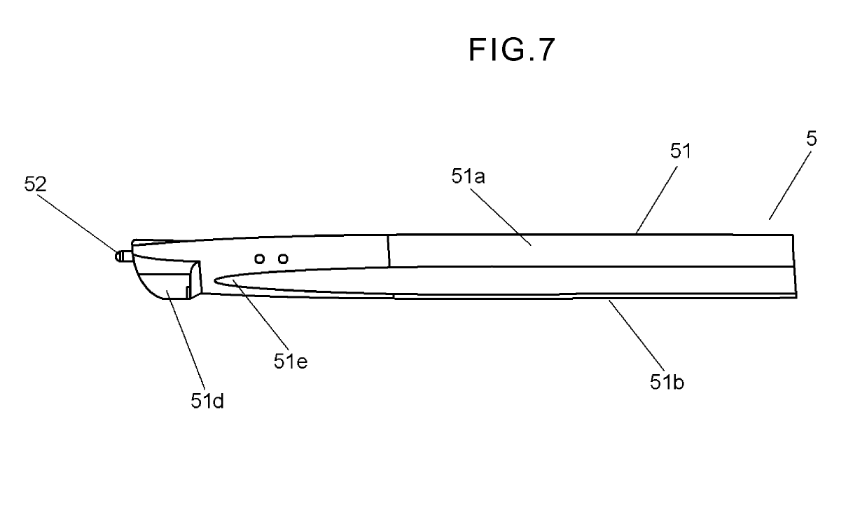

FIG. 6 is a perspective view illustrating an external appearance of the electronic pen according to the exemplary embodiment of the present technology. FIG. 7 is a plan view illustrating the external appearance of the electronic pen according to the exemplary embodiment of the present technology as viewed in the horizontal direction.

As illustrated in FIGS. 6 and 7, electronic pen 5 includes resin-made cylindrical case 51 constituted by upper case 51a and lower case 51b. Case 51 includes a light source unit which applies infrared light to information pattern 3, and an image reading unit which reads information from information pattern 3. Case 51 further includes a battery and other components as well as the light source unit and the image reading unit. Provided at a tip of case 51 is opening portion 51c through which infrared light is emitted and into which infrared light reflected on the display device enters. Pen tip 52 projects from opening 51c toward the tip. The internal structure of electronic pen 5 will be detailed later.

Further provided at a tip portion of case 51 are projecting portion 51d which has a larger diameter than the diameter of the other portion of case 51, and holding portion 51e disposed on the rear side of projecting portion 51e and having a smaller diameter than the diameter of the other portion of case 51.

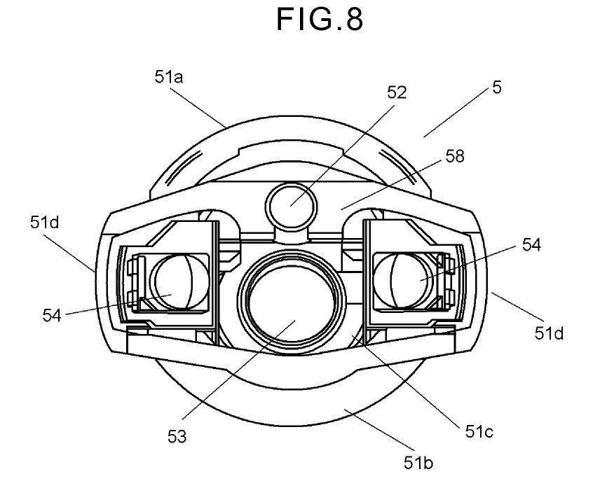

FIG. 8 is a plan view illustrating the electronic pen according to the exemplary embodiment of the present technology as viewed from the opening portion side at the tip of the electronic pen. As illustrated in FIG. 8, electronic pen 5 includes image reading unit 53 disposed substantially at the center of opening portion 51c at the tip of case 51, as a unit for receiving infrared light reflected on display device 2 to read images based on the infrared light. Two light source units 54 are further provided on both sides of image reading unit 53 positioned at the center of opening 51c of case 51. Each of light source units 54 is constituted by an LED functioning as a light source for emitting infrared light, and a condensing lens. Two light source units 54 are disposed in projecting portion 51d formed at the tip portion of case 51. In this configuration, two light source units 54 positioned at the tip portion applies infrared light to display device 2 having information pattern 3 as a reading target, and image reading unit 53 positioned substantially at the center reads the reflected infrared light.

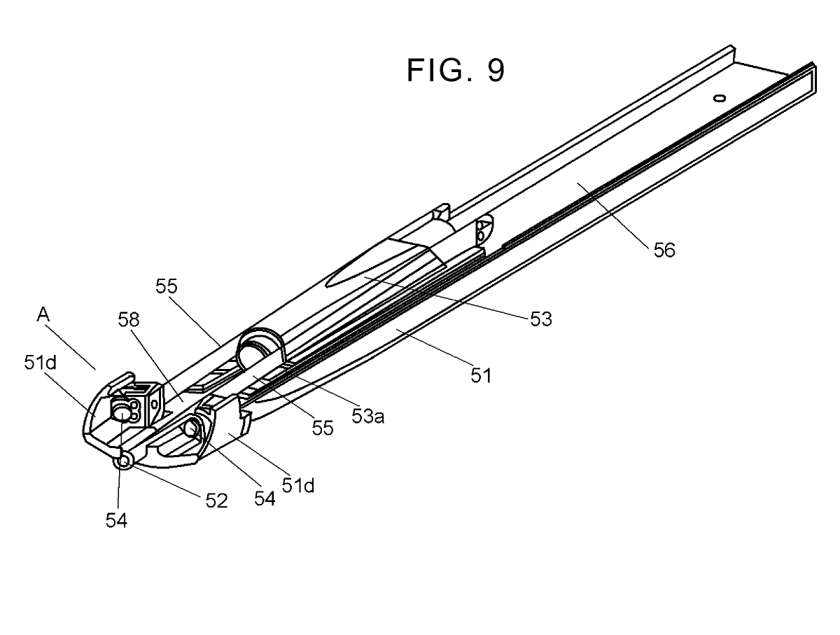

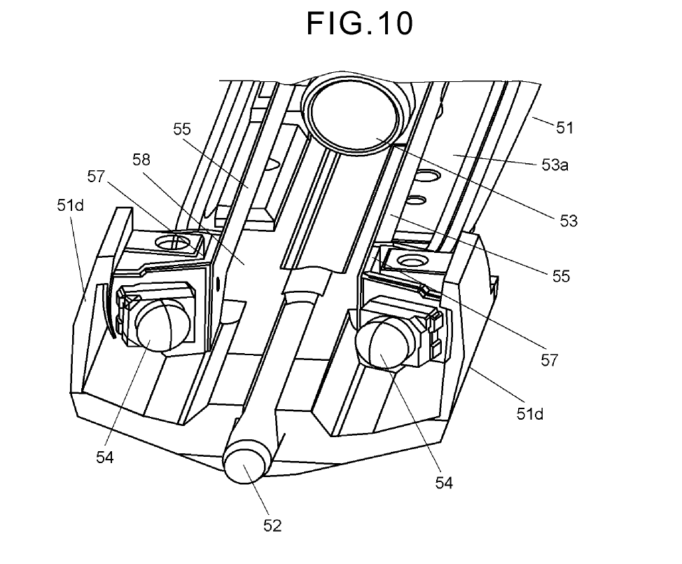

FIG. 9 is a perspective view illustrating the internal structure of the electronic pen according to the exemplary embodiment of the present technology in a state where the lower case is removed from the pen. FIG. 10 is a perspective view illustrating enlarged A part shown in FIG. 9.

As illustrated in FIGS. 9 and 10, each of two light source units 54 includes the LED as the light source for emitting infrared light, and flexible wiring plate 55 on which the LED is mounted. Flexible wiring plate 55 is electrically connected with control circuit board 56 incorporated in the rear part of case 51. Each of light source units 54 includes a heat conducting portion formed on the rear surface opposite to the surface of flexible wiring plate 55 on which the LED of light source unit 54 is mounted. The heat conducting portion includes L-shaped metal plate 57 attached via a heat conductive adhesive member to allow dissipation of heat generated from the LED of light source unit 54 through metal plate 57. This configuration achieves effective heat dissipation through the heat conducting portion, and thus increases life of the LED.

As illustrated in FIG. 10, one surface of L-shaped metal plate 57 to which the LED of light source unit 54 is attached is disposed on the rear surface opposite to the surface of flexible wiring plate 55 on which the LED is mounted, while the other surface of L-shaped metal plate 57 is bended in such a manner as to extend away from projecting portion 51d of case 51 toward the inside of case 51. This configuration allows heat generated from the LED of light source unit 54 to escape from projecting portion 51d toward the inside of case 51 via metal plate 57 of the heat conducting portion. Accordingly, the user does not easily sense the heat of light source unit 54 when holding electronic pen 5.

Metal plate 57 may have arbitrary shapes other than the L shape. For example, metal plate 57 may have a flat plate shape. In this case, one surface of metal plate 57 on the tip portion side may be attached to the rear surface opposite to the surface of flexible wiring plate 55 where the LED of light source unit 54 is mounted, while the other surface of metal plate 57 on the rear end portion side may be configured to extend away from projecting portion 51d of case 51 toward the inside of case 51.

The heat conducting portion may be formed as metal patterns made of copper, for example, on the rear surface opposite to the surface of flexible wiring plate 55 on which the LED is mounted. In this case, flexible wiring plate 55 is provided such that a part of the heat conducting portion extends away from projecting portion 51d of case 51 toward the inside of case 51.

Two light source units 54 are positioned such that metal plates 57 is attached to support member 58 supporting pen tip 52, which constitutes light source units housed at the tip portion of case 51.

Attachment portion 53a of image reading unit 53 is attached to a rear part of support member 58 via a screw (not shown). A wiring portion extended from image reading unit 53 is electrically connected with control circuit board 56.

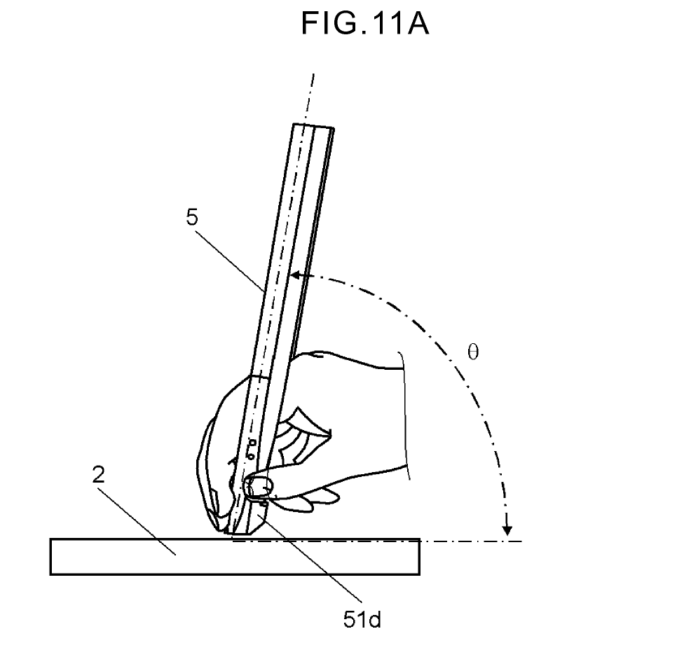

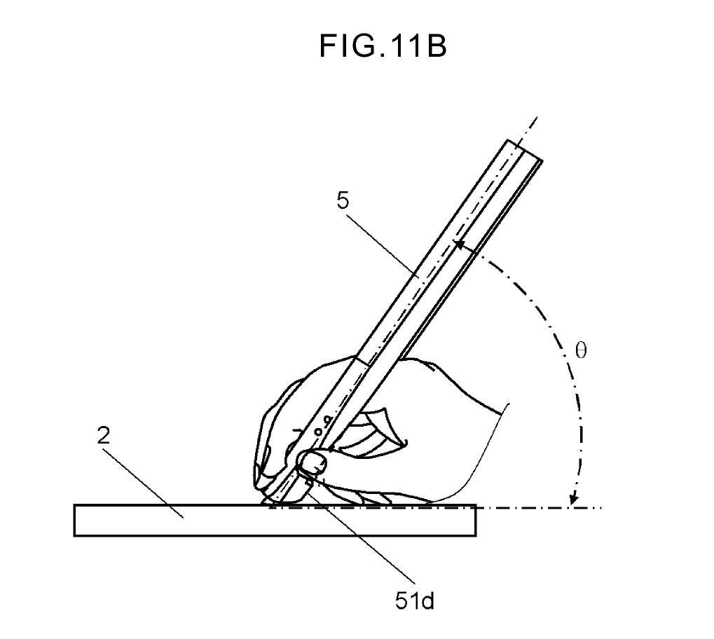

FIGS. 11A and 11B are explanatory views each illustrating a state in which a user uses the electronic pen according to one exemplary embodiment of the present technology. FIG. 11A illustrates the electronic pen during use in a position raised substantially in the vertical direction, while FIG. 11B illustrates the electronic pen during use in a position with inclination.

As illustrated in FIGS. 11A and 11B, in the electronic pen of the present technology which includes the projecting portion 51d at the tip portion of case 51, the inclination of the electronic pen during use is regulated in such a manner as to form an inclination angle θ allowing accurate information reading from information pattern 3, such as the inclination angle θ of 45° or larger, with respect to display surface 2a of display device 2, i.e., with respect to information pattern 3 when electronic pen 1 is used.

In the electronic pen of the present technology, as described above, each of the light sources of light source units 54 is mounted on flexible wiring plate 55, while the heat conducting portion is formed on the rear surface opposite to the surface of flexible wiring plate 55 on which the light source is mounted. This configuration allows effective dissipation of heat generated from the light sources through the heat conducting portion, and thus increases life of the light sources.

According to this exemplary embodiment discussed herein, infrared light is used as light for detecting coordinate information formed on information pattern 3. However, the present technology is not limited to the specific example which uses infrared light. For example, instead of the use of infrared light, light with a wavelength in visible light region may be used as light for detecting coordinate information formed in information pattern 3, when mark 31 of information pattern 3 is made of a material capable of absorbing or reflecting light with a wavelength in visible light region, such as blue, green, red, or other colors.

Accordingly, the present technology is useful in providing an information display apparatus capable of achieving highly accurate handwriting input.

What is claimed is:

1. An information reader comprising:
a light source unit that applies light to an information pattern having a plurality of marks which are optically readable;
an image reading unit that reads information from the information pattern; and
a case that houses the light source unit and the image reading unit, and includes, at a tip, an opening through which the light from the light source unit is applied to the information pattern and into which light for reading information by the image reading unit enters,
wherein
the light source unit includes a light source that emits light, a flexible wiring plate on which the light source is mounted, and a heat conducting unit provided on a rear surface opposite to a surface of the flexible wiring plate on which the light source is mounted.

2. The information reader according to claim 1, wherein
a tip portion of the case includes a projecting portion that has a diameter larger than a diameter of another portion of the case,
the light source unit is disposed on the projecting portion,
the light source unit includes the light source that emits light, the flexible wiring plate on which the light source is mounted, and a heat conducting unit provided on a rear surface opposite to the surface of the flexible wiring plate on which the light source is mounted, and
a part of the heat conducting unit is disposed in such a manner as to extend away from the projecting portion of the case toward an inside of the case.

3. The information reader according to claim 2, wherein
the heat conducting unit has a metal plate,
one of surfaces of the metal plate is disposed on the rear surface opposite to the surface of the flexible wiring plate on which the light source is mounted, and
the other surface of the metal plate is disposed in such a manner as to extend away from the projecting portion of the case toward the inside of the case.

4. The information reader according to claim 2, wherein the projecting unit at the tip portion of the case regulates inclination of the case in a state of use of the information reader in such a manner as to form an inclination angle that allows reading of information with respect to the information pattern, when the information reader is used.

5. The information reader according to claim 1, wherein the information pattern is disposed on a display device and indicates position information on a display surface of the display device.

6. An information reader comprising:
a light source unit that applies light to an information pattern having a plurality of marks which are optically readable;
an image reading unit that reads information from the information pattern; and
a case that houses the light source unit and the image reading unit, and includes, at a tip, an opening through which the light from the light source unit is applied to the information pattern and into which light for reading information by the image reading unit enters,
wherein
a tip portion of the case includes a projecting portion that has a diameter larger than a diameter of another portion of the case,
the light source unit is disposed on the projecting portion,
the light source unit includes a light source that emits light, a flexible wiring plate on which the light source is mounted, and a metal plate disposed on a rear surface opposite to a surface of the flexible wiring plate on which the light source is mounted, and
a part of the metal plate is disposed in such a manner as to extend away from the projecting portion of the case toward an inside of the case.
